(19) United States
(12) Patent Application Publication
(10) Pub. No.: US 2024/0093994 A1
(43) Pub. Date: Mar. 21, 2024

(54) Inertial Measurement Device

(71) Applicant: SEIKO EPSON CORPORATION, Tokyo (JP)

(72) Inventor: Yoshiyuki MATSUURA, Shiojiri (JP)

(21) Appl. No.: 18/467,306

(22) Filed: Sep. 14, 2023

(30) Foreign Application Priority Data
Sep. 15, 2022 (JP) 2022-146827

(51) Int. Cl. G01C 19/56; G01P 1/00; G01P 15/125; G01P 15/18

(52) U.S. Cl. CPC G01C 19/56; G01P 1/00; G01P 15/125; G01P 15/18

(57) ABSTRACT

An inertial measurement device includes: a first case and a second case; a board that is disposed in a space formed by the first case and the second case, that includes a first surface and a second surface, and in which a first inertial sensor is disposed at the first surface; a first filling material configured to fill between the first surface of the board and the first case and between the first inertial sensor and the first case; and a second filling material configured to fill between the second surface of the board and the second case.

The present application is based on, and claims priority from JP Application Serial Number 2022-146827, filed on Sep. 15, 2022, the disclosure of which is hereby incorporated by reference herein in its entirety.

### BACKGROUND

### 1. Technical Field

The present disclosure relates to an inertial measurement device.

### 2. Related Art

There is known an inertial measurement device including a plurality of inertial sensors such as an acceleration sensor and an angular velocity sensor. For example, JP-A-2017-20829 discloses a sensor unit including a six-axis motion sensor including an acceleration sensor of three axes and angular velocity sensors of three axes. According to this document, the acceleration sensor is a capacitive acceleration sensor obtained by processing a silicon substrate by a MEMS technique, and is mounted on a circuit board together with the angular velocity sensor and accommodated in a metal case. The acceleration sensor is a surface-mounted component, and is surface-mounted on the board by soldering.

According to this document, a recess is formed in an aluminum inner case, and the acceleration sensor mounted on a first surface of the board is accommodated in a space formed by the board and the recess. The space is filled with a filling material. Electronic components are also mounted on a second surface side of the board opposite from the first surface, but no filling material is provided on the second surface side. This reduces influence of external noise and vibration and improves stability in detection accuracy.

The sensor unit disclosed in JP-A-2017-20829 has room for improvement. Specifically, a stress may be non-uniform due to a fact that the filling material is provided only on a first surface side of the board. For example, when moisture enters from the second surface side of the board and the filling material absorbs the moisture, the filling material may expand. At this time, the expansion of the filling material does not occur on the first surface side backed by the highly rigid inner case, but occurs on the second surface side of the board, and bends the board to push the board toward the second surface side. This bending may affect the detection accuracy of the acceleration sensor.

That is, an inertial measurement device having excellent moisture resistance and high detection accuracy has been required.

### SUMMARY

An inertial measurement device according to an aspect of the present application includes: a first case and a second case, which have rigidity; a board that is disposed in a space formed by the first case and the second case, that includes a first surface and a second surface, and in which a first inertial sensor is disposed at the first surface; a first filling material configured to fill between the first surface of the board and the first inertial sensor, and the first case; and a second filling material configured to fill between the second surface of the board and the second case.

### BRIEF DESCRIPTION OF THE DRAWINGS

FIG. 1 is a perspective view showing a mode of fixing an inertial measurement device according to a first embodiment to a mounting target surface.

FIG. 2 is a perspective view of the inertial measurement device observed from a mounting target surface side.

FIG. 3 is an exploded perspective view of the inertial measurement device.

FIG. 4 is a perspective view of a circuit board.

FIG. 5 is a perspective cross-sectional view taken along a line f-f in FIG. 2.

FIG. 6 is a cross-sectional view taken along the line f-f in FIG. 2.

FIG. 7 is a cross-sectional view taken along a line b-b in FIG. 1.

FIG. 8 is a plan view of an inner case.

FIG. 9 is a plan view of an outer case.

FIG. 10 is a cross-sectional view of an inertial measurement device according to a second embodiment.

FIG. 11 is a cross-sectional view of an inertial measurement device according to a third embodiment.

FIG. 12 is a cross-sectional view of an inertial measurement device according to a fourth embodiment.

FIG. 13 is a cross-sectional view of an inertial measurement device according to a fifth embodiment.

FIG. 14 is a perspective view of a circuit board according to a sixth embodiment.

FIG. 15 is a cross-sectional view of an inertial measurement device.

### DESCRIPTION OF EMBODIMENTS

### First Embodiment

### Outline of Inertial Measurement Device

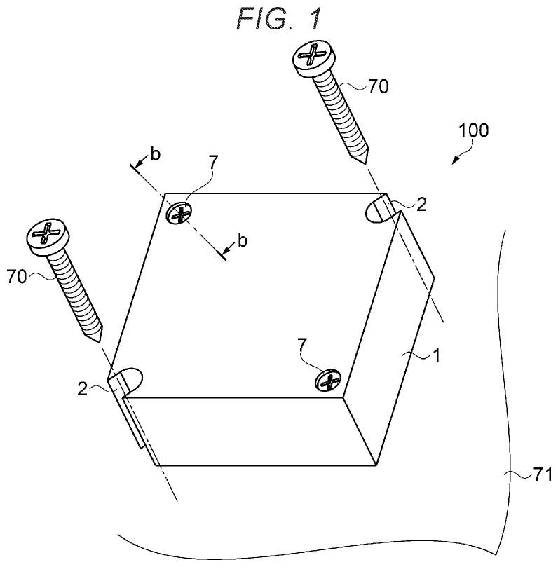

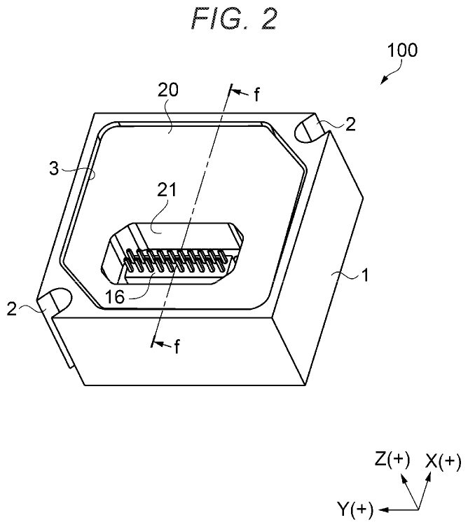

FIG. 1 is a perspective view showing a mode of fixing an inertial measurement device according to a first embodiment to a mounting target surface. FIG. 2 is a perspective view of the inertial measurement device observed from a mounting target surface side.

First, an outline of an inertial measurement device 100 according to the embodiment will be described.

The inertial measurement device 100 shown in FIG. 1 is an inertial measurement unit (IMU) that detects the posture and behavior of a mounting target body such as an automobile or a robot. The inertial measurement device 100 functions as a so-called six-axis motion sensor including an acceleration sensor of three axes and angular velocity sensors of three axes.

The inertial measurement device 100 is formed into a rectangular parallelepiped having a substantially square shape in a plan view, and is compactly formed such that a length of one side of the square is approximately several centimeters. Two cutout holes 2 are formed in a diagonal direction of the inertial measurement device 100. The inertial measurement device 100 is fixed to a mounting target surface 71 of a mounting target body such as an automobile by two attachment screws 70 inserted into the cutout holes 2. The mounting target body is not limited to a moving body such as an automobile, and may be a structure such as a bridge, an elevated road, or a track. When being mounted to a structure, inertial measurement device 100 is used as a structural health monitoring system that checks health of the structure.

### Basic Configuration of Inertial Measurement Device

As shown in FIG. 2, the inertial measurement device 100 has a configuration in which an inner case 20 is accommodated in an outer case 1 having a rectangular parallelepiped shape. A rectangular opening 21 is formed in the inner case 20. Hereinafter, a long side direction of the opening 21 is defined as a Y(+) direction. As indicated by coordinate axes in the following description, a direction orthogonal to the Y(+) direction is defined as an X(+) direction, and a thickness direction of the outer case 1 is defined as Z(+). A plug-type connector 16 is exposed from the opening 21 of the inner case 20, and the Y(+) direction coincides with an arrangement direction of a plurality of pins of the connector 16.

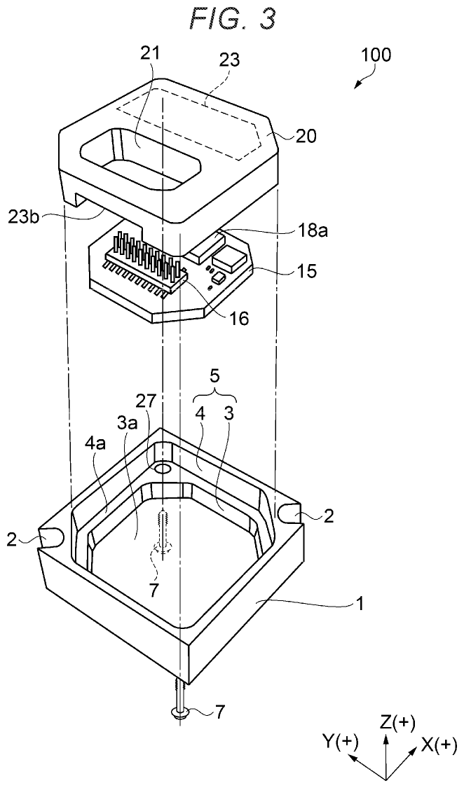

FIG. 3 is an exploded perspective view of the inertial measurement device.

As shown in FIG. 3, the inertial measurement device 100 includes the outer case 1, a circuit board 15 as a board, and the inner case 20. The inner case 20 corresponds to a first case, and the outer case 1 corresponds to a second case.

The outer case 1 is a box-shaped housing having a rectangular parallelepiped outer shape. In a preferred example, aluminum is used as a material. The material is not limited to aluminum, and may be any highly rigid material that does not swell, such as metal or ceramic. Titanium, magnesium, or stainless steel may be used as the metal. The outer case 1 and the inner case 20 are preferably made of the same material.

The two cutout holes 2 described above are formed in an outer side of the outer case 1. The configuration is not limited to the cutout hole 2, and for example, a round hole (through hole) may be formed and screwed, or a flange (ear) may be formed on a side surface of the outer case 1 and the flange portion may be screwed.

The outer case 1 includes an accommodating portion 5 that accommodates the inner case 20 in which the circuit board 15 is set.

The accommodating portion 5 includes a board accommodating portion 3 having a bottom 3a as a base and a main accommodating portion 4 surrounding the board accommodating portion 3. A receiving portion 4a is formed between the board accommodating portion 3 and the main accommodating portion 4. The receiving portion 4a is a ring-shaped stopper portion rising stepwise from the bottom 3a, and supports an outer peripheral edge of the inner case 20. The inner case 20 is accommodated in the main accommodating portion 4, and the circuit board 15 is accommodated in the board accommodating portion 3.

In other words, the inner case 20 as the first case is accommodated in the accommodating portion 5 of the outer case 1 as the second case, and the accommodating portion 5 includes the receiving portion 4a as the stopper portion for preventing the inner case 20 from falling.

The inner case 20 is a member that supports the circuit board 15, and has a shape capable of being accommodated in the main accommodating portion 4 of the outer case 1. The inner case 20 is made of the same material as that of the outer case 1, and is made of aluminum in a preferred example. In other words, the outer case 1 and the inner case 20 have rigidity.

The inner case 20 has the opening 21 for exposing the connector 16 on the circuit board 15 to the outside, and a cavity 23 that is a recess for accommodating an electronic component mounted on the circuit board 15. In other words, the circuit board 15 is disposed in a space, which is formed by the inner case 20 and the outer case 1 and includes the cavity 23 and the accommodating portion 5. Although the cavity 23 is actually filled with resin, the resin is not shown in FIG. 3. The board accommodating portion 3 of the accommodating portion 5 in the outer case 1 is also filled with resin in the same manner, but the resin is not shown in FIG. 3.

As shown in FIG. 3, the outer case 1 and the inner case 20 are fixed by two fixing screws 7 in a state in which the inner case 20 including the circuit board 15 is accommodated in and integrated with the accommodating portion 5 of the outer case 1. The two fixing screws 7 are provided at diagonal positions (see FIG. 1) different from the two cutout holes 2 for mounting the inertial measurement device 100.

### Configuration of Circuit Board

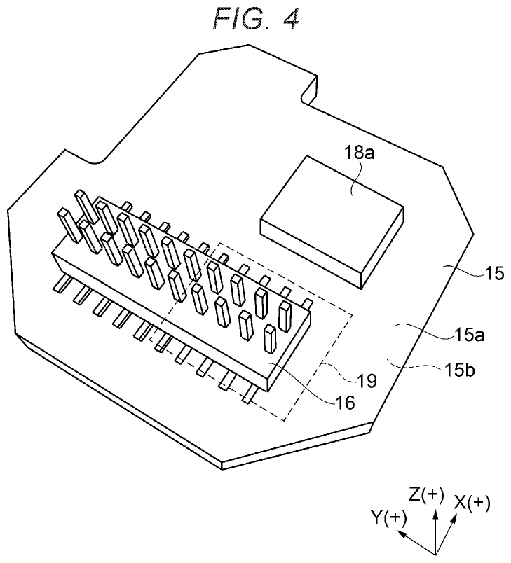

FIG. 4 is a perspective view of the circuit board.

The circuit board 15 is a multilayer glass epoxy board in a preferred example. An outer shape of the circuit board 15 is a deformed octagonal shape with some parts cut off in a plan view. The board is not limited to the glass epoxy board, and any rigid board may be used on which electronic components can be mounted. For example, a composite board may be used. A surface of the circuit board 15 on a Z(+) side is referred to as a first surface 15a, and an opposite-side surface thereof from the first surface 15a is referred to as a second surface 15b. The first surface 15a is also referred to as a front surface, and the second surface 15b is also referred to as a back surface. In the circuit board 15, electronic components are also mounted on side surfaces of the board.

As shown in FIG. 4, the connector 16 extends on the first surface 15a along one side of the circuit board 15. The connector 16 is a plug-type connector, and includes two rows of coupling terminals arranged at an equal pitch along the Y(+) direction. A shroud-type connector including a wall surrounding the coupling terminals may also be used.

An inertial sensor 18a as a first inertial sensor is disposed in the X(+) direction of the connector 16 on the first surface 15a. The inertial sensor 18a uses a capacitive acceleration sensor capable of detecting accelerations in three directions (three axes) of the X axis, the Y axis, and the Z axis by one device and obtained by processing a silicon substrate using the MEMS technique. In a preferred example, the inertial sensor 18a is a surface-mounted component including a resin package molded with resin, and is surface-mounted on an electrode pad (not shown) provided at the first surface 15a of the circuit board 15 by soldering. The inertial sensor 18a may be a six-axis combo sensor including a three-axis gyro sensor in addition to the three-axis acceleration sensor. The package is not limited to the resin package, and may be a ceramic package.

A plurality of electronic components other than the inertial sensor 18a are mounted on the first surface 15a of the circuit board 15, but are not shown.

A control IC 19 is mounted on the second surface 15b of the circuit board 15. The control IC 19 is a micro controller unit (MCU), includes a built-in storage unit including a nonvolatile memory, and controls units of the inertial measurement device 100 in an integrated manner. The storage unit stores a program that defines an order and contents for detecting an acceleration and an angular velocity, a program that incorporates detection data into packet data, accompanying data, and the like.

A plurality of electronic components other than the control IC 19 are also mounted on the second surface 15b, but are not shown in the drawing.

### Arrangement Mode of Filling Material

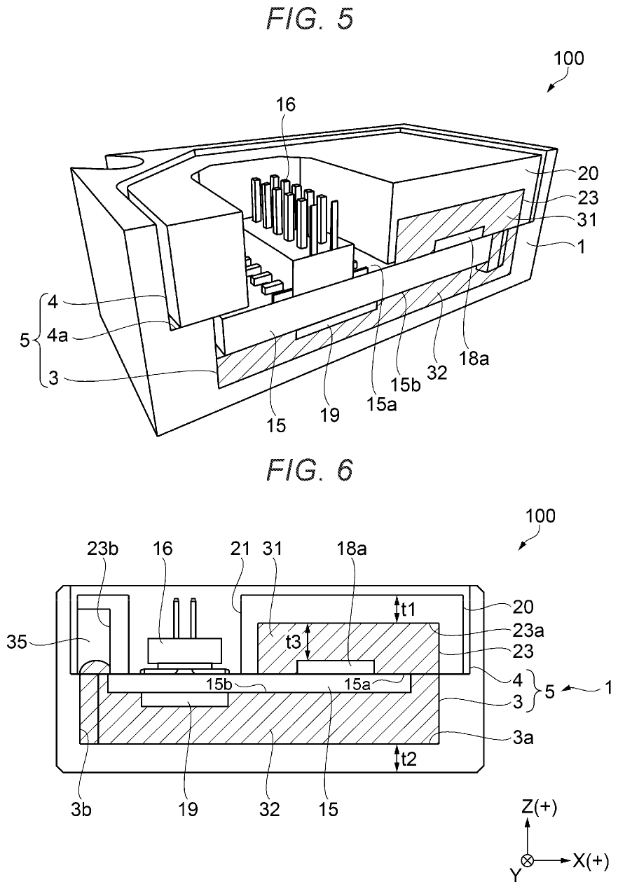

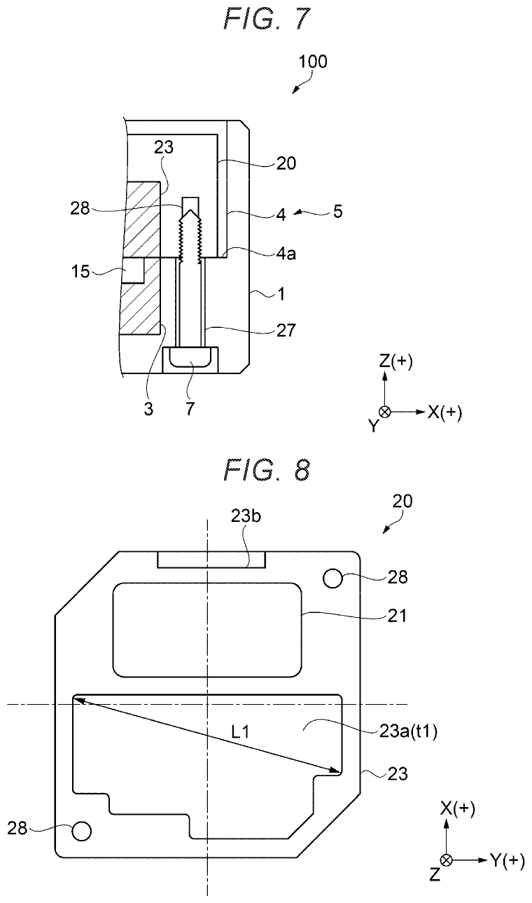

FIG. 5 is a perspective cross-sectional view taken along a line f-f in FIG. 2. FIG. 6 is a cross-sectional view taken along the line f-f in FIG. 2. FIG. 7 is a cross-sectional view taken along a line b-b in FIG. 1.

As shown in FIGS. 5 and 6, the circuit board 15 and the inner case 20 are accommodated in the accommodating portion 5 of the outer case 1.

Here, the cavity 23 of the inner case 20 is filled with a filling material 31 as a first filling material, and the board accommodating portion 3 of the outer case 1 is filled with a filling material 32 as a second filling material. The filling material 31 covers the electronic components including the inertial sensor 18a and fills the cavity 23. Similarly, the filling material 32 covers the electronic components including the control IC 19 and fills the board accommodating portion 3. In other words, the filling material 31 fills between the first surface 15a of the circuit board 15 and the inertial sensor 18a as the first inertial sensor, and the inner case 20 as the first case. The filling material 32 fills between the second surface 15b of the circuit board 15 and the outer case 1 as the second case.

A hard material having low hygroscopicity and a small coefficient of thermal expansion is suitable for the filling materials 31 and 32. In a preferred example, epoxy resin is used as the filling materials 31 and 32. Specifically, a one-liquid thermosetting epoxy adhesive is used. Hardness of the epoxy adhesive after curing is preferably 80 D or more and more preferably 90 D or more, as measured by a type D durometer in a durometer hardness test of JIS7215-1986. The epoxy resin containing a filler may be used.

A purpose of filling front and back surfaces of the circuit board 15 with the filling materials 31 and 32 is to prevent entry of humidity by sealing the inertial sensor 18a with the filling material 31, and to prevent warping of the circuit board 15 by integrating a first surface 15a side of the circuit board 15 with the inner case 20 and a second surface 15b side with the outer case 1. Therefore, the filling materials 31 and 32 are preferably made of resin having high hardness after curing.

According to a method for assembling the inertial measurement device 100, first, the circuit board 15 is set in the inner case 20. Specifically, under an atmospheric pressure, the cavity 23 is filled with the filling material 31, and then the circuit board 15 is set. Next, under the atmospheric pressure, the inner case 20 including the circuit board 15 is set to the outer case 1 in which the board accommodating portion 3 is filled with the filling material 32. The above steps may be performed under a reduced pressure environment, or a step performed under the atmospheric pressure and a step performed under the reduced pressure environment may be combined.

As shown in FIG. 7, the fixing screw 7 is inserted into a through hole 27 of the outer case 1, and is screwed and fixed to a prepared hole 28 of the inner case 20. Two prepared holes 28 are formed at diagonal positions of the inner case 20 (FIG. 7). In a preferred example, after tightening the screws, the inertial measurement device 100 is set in a high-temperature environment, and the filling materials 31 and 32 are thermally cured. The filling material 31 may be cured first at a stage when the circuit board 15 is set in the inner case 20. The fixing screws 7 may be omitted. Since the front and back surfaces of the circuit board 15 are filled with the filling materials 31 and 32, a strength of the structure can be ensured only by an adhesive force of the filling materials 31 and 32.

### Configuration Mode of Case

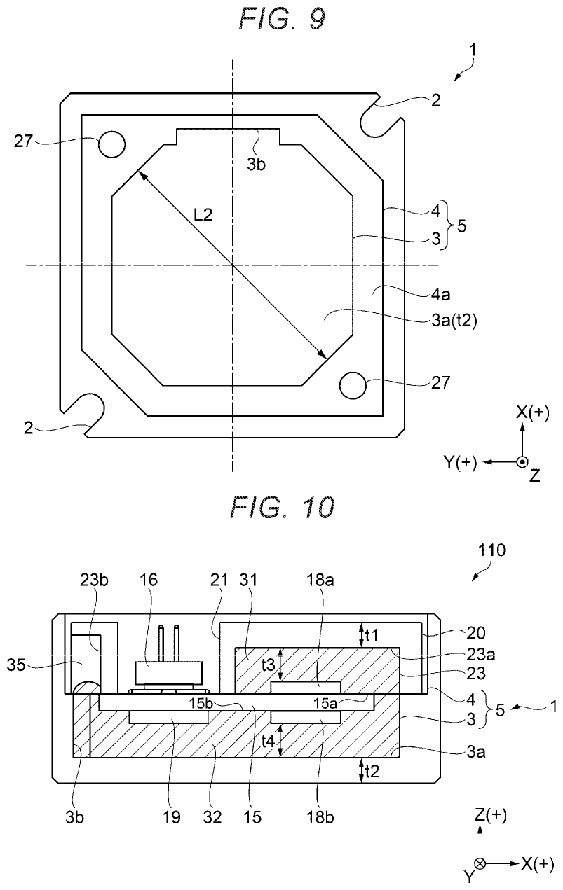

FIG. 8 is a plan view of the inner case. FIG. 9 is a plan view of the outer case.

FIG. 8 is a plan view of the inner case 20 viewed from an installation surface for the circuit board 15.

As described above, the inner case 20 and the outer case 1 are made of aluminum having high rigidity, and the cavity 23 filled with the filling material 31, the accommodating portion 5 filled with the filling material 32, and the like preferably have a structure capable of withstanding a stress due to swelling of the filling materials 31 and 32 or temperature variation.

As shown in FIG. 8, the inner case 20 has a hexagonal shape obtained by cutting one of diagonal portions of a square. The other of the diagonal portions has two prepared holes 28 into which the two fixing screws 7 are screwed.

The substantially rectangular cavity 23 is formed in an X minus direction of the rectangular opening 21. Here, a width of the cavity 23 is defined as a length L1. When a thickness of a bottom 23a (FIG. 6) of the cavity 23 is defined as a thickness t1, the cavity 23 is designed to satisfy the following formula (1). When a length of any diagonal line among diagonal lines in a shape of the cavity 23 is defined as the length L1, the following formula (1) may be satisfied. When the longest diagonal line among the diagonal lines in the shape of the cavity 23 is defined as the length L1, it is preferable to satisfy the following formula (1). When a length of the widest portion of the cavity 23 is defined as the length L1, the following formula (1) may be satisfied.

L1/t1<20 Formula (1)

Note that t1 is 0.5 mm or more.

For example, when the length L1 of the cavity 23 is 18 mm and the thickness t1 of the bottom 23a is 2 mm, 18/2=9, which satisfies the formula (1).

As shown in FIG. 6, a depth of the cavity 23 is set such that a dimension t3 from an upper of the inertial sensor 18a to the bottom 23a is 2 mm or less. The dimension t3 is preferably smaller than a thickness of the inertial sensor 18a.

As shown in FIG. 9, the main accommodating portion 4 of the accommodating portion 5 of the outer case 1 has a shape along an outer shape of the hexagonal inner case 20. The substantially octagonal board accommodating portion 3 is formed inside the main accommodating portion 4.

Here, a width of the board accommodating portion 3 is defined as a length L2. When a thickness of the bottom 3a (FIG. 6) of the board accommodating portion 3 is defined as a thickness t2, the board accommodating portion 3 is designed to satisfy the following formula (2). When a length of any diagonal line among diagonal lines in a shape of the board accommodating portion 3 is defined as the length L2, the following formula (2) may be satisfied. When the longest diagonal line among the diagonal lines in the shape of the board accommodating portion 3 is defined as the length L2, it is preferable to satisfy the following formula (2). When a length of the widest portion of the board accommodating portion 3 is defined as the length L2, the following formula (2) may be satisfied.

L2/t2<20 Formula (2)

Note that t2 is 0.5 mm or more.

For example, when the length L2 of the board accommodating portion 3 is 21 mm and the thickness t2 of the bottom 3a is 2 mm, 21/2=10.5, which satisfies the formula (2).

In this way, according to verification results of the inventors and the like, it is confirmed that a structure capable of withstanding the stress due to the swelling of the filling materials 31 and 32 or the temperature variation is obtained by designing the cavity 23 of the inner case 20 and the board accommodating portion 3 of the outer case 1 in a manner of satisfying the formulas (1) and (2).

As shown in FIG. 9, a cutout portion 3b as a second cutout portion is formed on one side of the board accommodating portion 3 of the outer case 1. The cutout portion 3b is a portion obtained by cutting out a part of the receiving portion 4a to increase an area of the board accommodating portion 3.

As shown in FIG. 8, a cutout portion 23b as a first cutout portion is formed on one side of the outer shape of the inner case 20. The cutout portion 23b corresponds to the cutout portion 3b of the outer case 1, and is formed such that the two cutout portions 3b and 23b overlap each other when the inner case 20 is accommodated.

FIG. 6 shows a state in which the two cutout portions 3b and 23b overlap each other. Specifically, on an X minus side of the control IC 19, a storage portion 35 is shown which is a space formed by the cutout portion 3b and the cutout portion 23b overlapping in a Z direction. The storage portion 35 is a storage portion that stores the overflowed filling material 32 when the filling material 32 overflows. The storage portion 35 may be provided at a plurality of locations.

In other words, the cutout portion 23b is formed on the one side of the inner case 20, the cutout portion 3b is formed in the accommodating portion 5 of the outer case 1, and the storage portion 35 that stores the overflowed filling material 32 is formed by the cutout portion 23b and the cutout portion 3b when the inner case 20 is set in the accommodating portion 5 of the outer case 1.

As described above, according to the inertial measurement device 100 in the embodiment, the following effects can be attained.

The inertial measurement device 100 includes: the inner case 20 as the first case and the outer case 1 as the second case, which have rigidity; the circuit board 15 that is disposed in the space formed by the inner case 20 and the outer case 1, that includes the first surface 15a and the second surface 15b, and in which the inertial sensor 18a as the first inertial sensor is disposed at the first surface 15a; the filling material 31 as the first filling material that fills between the first surface 15a of the circuit board 15 and the inertial sensor 18a, and the inner case 20; and the filling material 32 as the second filling material that fills between the second surface 15b of the circuit board 15 and the outer case 1.

According to this, the first surface 15a side of the circuit board 15 is filled with the filling material 31, and the second surface 15b side is filled with the filling material 32. That is, the circuit board 15 is filled with the filling materials 31 and 32 on the front and back surfaces thereof, and is integrated with the inner case 20 and the outer case 1 to be rigid. This can prevent warping of the circuit board 15.

As shown in FIG. 6, since the front and back surfaces and a peripheral edge portion of the circuit board 15 are almost covered with the filling materials 31 and 32, entry of moisture into the circuit board 15 can be prevented.

Therefore, it is possible to provide the inertial measurement device 100 having excellent moisture resistance and high detection accuracy.

The inner case 20 is accommodated in the accommodating portion 5 of the outer case 1, and the accommodating portion 5 includes the receiving portion 4a as a stopper portion that prevents the inner case 20 from falling.

According to this, since the inner case 20 can be set at an appropriate position in the accommodating portion 5, the filling materials 31 and 32 can fill by an appropriate amount (thickness).

The cutout portion 23b is formed on the one side of the inner case 20, the cutout portion 3b is formed in the accommodating portion 5 of the outer case 1, and the storage portion 35 that stores the overflowed filling material 32 is formed by the cutout portion 23b and the cutout portion 3b when the inner case 20 is set in the accommodating portion 5 of the outer case 1.

According to this, even when an amount of the filling material 32 is large and the filling material 32 overflows, the storage portion 35 can absorb the overflowed filling material 32. This can improve manufacturing efficiency.

The inertial sensor 18a is mounted on the first surface 15a of the circuit board 15 as described above, but the disclosure is not limited to this configuration, and the inertial sensor 18a may be mounted only on the second surface 15b of the circuit board 15. The same effects as those described above can also be attained according to this configuration.

### Second Embodiment

### Different Mounting Mode-1

FIG. 10 is a cross-sectional view of an inertial measurement device according to a second embodiment, and corresponds to FIG. 6.

One inertial sensor 18a is provided at the first surface 15a of the circuit board 15 in the above embodiment, but the disclosure is not limited to this configuration, and an inertial sensor may also be provided at the second surface 15b. For example, in the embodiment, an inertial sensor 18b is also mounted on the second surface 15b of the circuit board 15. Hereinafter, the same portions as those according to the above embodiment are denoted by the same reference signs, and redundant description thereof will be omitted.

As shown in FIG. 10, an inertial measurement device 110 according to the embodiment includes the inertial sensor 18b as a second inertial sensor at the second surface 15b in addition to the inertial sensor 18a on the first surface 15a. In a preferred example, the inertial sensor 18a and the inertial sensor 18b are mounted on the circuit board 15 at front-back symmetrical positions. The filling material 32 fills to cover the second surface 15b of the circuit board 15 and the inertial sensor 18b. A dimension t4 from an upper surface of the inertial sensor 18b to the bottom 3a of the board accommodating portion 3 of the outer case 1 is set to 2 mm or less. In a preferred example, the dimension t4 is set to the same dimension as the dimension t3 on an inertial sensor 18a side. Except for these points, a configuration is the same as that of the inertial measurement device 100 according to the first embodiment.

In other words, the inertial measurement device 110 includes the inertial sensor 18b as the second inertial sensor disposed at the second surface 15b of the circuit board 15, and the filling material 32 fills between the second surface 15b of the circuit board 15 and the inertial sensor 18b, and the outer case 1.

As described above, according to the inertial measurement device 110 in the embodiment, the following effects can be attained in addition to the effects according to the above embodiment.

The inertial measurement device 110 includes the inertial sensor 18b as the second inertial sensor disposed at the second surface 15b of the circuit board 15, and the filling material 32 fills between the second surface 15b of the circuit board 15 and the inertial sensor 18b, and the outer case 1.

According to this, the circuit board 15 is filled with the filling materials 31 and 32 on the front and back surfaces thereof, and is integrated with the inner case 20 and the outer case 1 to be rigid. This can prevent warping of the circuit board 15.

By averaging outputs of the inertial sensors 18a and 18b mounted on both surfaces of the circuit board 15, influence of a stress can be offset, and thus detection accuracy can be further improved.

Therefore, it is possible to provide the inertial measurement device 110 having excellent moisture resistance and high detection accuracy.

### Third Embodiment

### Different Mounting Mode-2

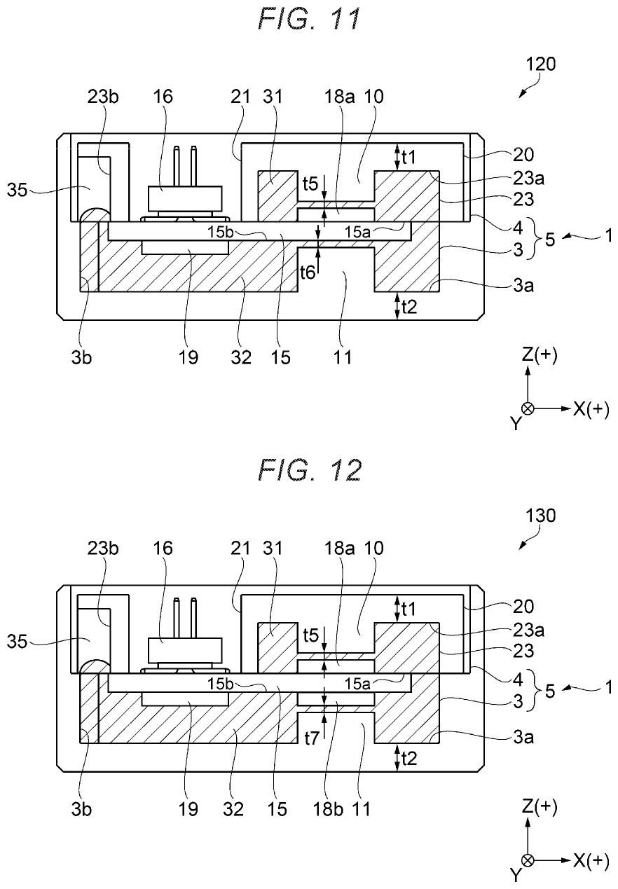

FIG. 11 is a cross-sectional view of an inertial measurement device according to a third embodiment, and corresponds to FIG. 6.

The dimension t3 from the upper surface of the inertial sensor 18a to the bottom 23a depends on the depth of the cavity 23 of the inner case 20 in the above embodiment, but the disclosure is not limited to this configuration, and an adjustment portion that adjusts the depth may be provided. For example, in the embodiment, a first protrusion 10 as a first adjustment portion is provided at the bottom 23a of the cavity 23. Hereinafter, the same portions as those according to the above embodiment are denoted by the same reference signs, and redundant description thereof will be omitted.

As shown in FIG. 11, an inertial measurement device 120 according to the embodiment includes the first protrusion 10 that is a protrusion protruding from the bottom 23a of the cavity 23 of the inner case 20 toward the circuit board 15, and a second protrusion 11 that is a protrusion protruding from the bottom 3a of the board accommodating portion 3 of the outer case 1 toward the circuit board 15.

A planar shape of the first protrusion 10 is formed into the same rectangular shape as a shape of the inertial sensor 18a, and a size thereof is substantially the same as that of the inertial sensor 18a. In a preferred example, a planar size of the first protrusion 10 is set to be slightly larger than that of the inertial sensor 18a. The planar size of the first protrusion 10 may be slightly smaller than that of the inertial sensor 18a. The planar shape of the first protrusion 10 may be different, and for example, the shape of the inertial sensor 18a may be rectangular, and the planar shape of the first protrusion 10 may be hexagonal or circular. The second protrusion 11 as a second adjustment portion is provided at a rear side of the inertial sensor 18a, and has the same planar shape and size as those of the first protrusion 10. Although the planar shape and size of the second protrusion 11 are the same as those of the first protrusion 10 in a preferable example, at least one of the planar shape and the size may be different.

A dimension between the first protrusion 10 and the inertial sensor 18a is a dimension t5, and the filling material 31 fills between the first protrusion 10 and the inertial sensor 18a. A dimension between the second protrusion 11 and the second surface 15b of the circuit board 15 is a dimension t6, and the filling material 32 fills between the second protrusion 11 and the second surface 15b. In other words, the inner case 20 includes the first protrusion 10 as the first adjustment portion that adjusts a thickness of the filling material 31 such that a portion overlapping the inertial sensor 18a in a plan view is thinner than other portions, and the outer case 1 includes the second protrusion 11 as the second adjustment portion that adjusts a thickness of the filling material 32 such that a portion overlapping the inertial sensor 18a in the plan view is thinner than other portions. Except for these points, a configuration is the same as that of the inertial measurement device 100 according to the first embodiment.

In a preferred example, a height of the first protrusion 10 is set such that the dimension t5 is 2 mm or less. More preferably, the height is set such that the dimension t5 is 1 mm or less. A height of the second protrusion 11 is set such that the dimension t6 is equal to the dimension t5. In other words, heights of the first protrusion 10 and the second protrusion 11 are adjusted such that the thickness of the filling material 31 and the thickness of the filling material 32 are substantially the same in portions overlapping the inertial sensor 18a in the plan view. The thickness of the filling material 31 is the same as the thickness of the filling material 32 in a preferred example, and may be different.

As described above, according to the inertial measurement device 120 in the embodiment, the following effects can be attained in addition to the effects according to the above embodiment.

According to the inertial measurement device 120, the inner case 20 includes the first protrusion 10 as the first adjustment portion that adjusts the thickness of the filling material 31 such that the portion overlapping the inertial sensor 18a in the plan view is thinner than other portions, and the outer case 1 includes the second protrusion 11 as the second adjustment portion that adjusts the thickness of the filling material 32 such that the portion overlapping the inertial sensor 18a in the plan view is thinner than other portions.

According to this, the circuit board 15 is filled with the filling materials 31 and 32 on the front and back surfaces thereof, and is integrated with the inner case 20 and the outer case 1 to be rigid. This can prevent warping of the circuit board 15.

Since thicknesses of the filling materials 31 and 32 can be reduced by providing the first protrusion 10 and the second protrusion 11, when resin forming the filling materials 31 and 32 absorbs moisture, an expansion amount of the resin present in a thickness direction of the inertial sensor 18a can be minimized, and influence of a stress applied to the inertial sensor 18a can be further limited.

Therefore, it is possible to provide the inertial measurement device 120 having excellent moisture resistance and high detection accuracy.

### Fourth Embodiment

### Different Mounting Mode-3

FIG. 12 is a cross-sectional view of an inertial measurement device according to a fourth embodiment, and corresponds to FIGS. 10 and 11.

A height adjustment portion structure using the protrusion described in the third embodiment may be applied to a configuration in which the inertial sensors 18a and 18b are provided at the front and back surfaces of the circuit board 15. Hereinafter, the same portions as those according to the above embodiment are denoted by the same reference signs, and redundant description thereof will be omitted.

As shown in FIG. 12, an inertial measurement device 130 according to the embodiment includes the inertial sensor 18b as a second inertial sensor at the second surface 15b in addition to the inertial sensor 18a on the first surface 15a. The inertial measurement device 130 further includes the first protrusion 10 that is a protrusion protruding from the bottom 23a of the cavity 23 of the inner case 20 toward the circuit board 15, and the second protrusion 11 that is a protrusion protruding from the bottom 3a of the board accommodating portion 3 of the outer case 1 toward the circuit board 15.

A dimension between the first protrusion 10 and the inertial sensor 18a is the dimension t5, and the filling material 31 fills between the first protrusion 10 and the inertial sensor 18a. A dimension between the second protrusion 11 and the inertial sensor 18b is a dimension t7, and the filling material 32 fills between the second protrusion 11 and the inertial sensor 18b.

In a preferred example, a height of the first protrusion 10 is set such that the dimension t5 is 2 mm or less. More preferably, the height is set such that the dimension t5 is 1 mm or less. A height of the second protrusion 11 is set such that the dimension t7 is equal to the dimension t5. In other words, the inertial measurement device 130 further includes the inertial sensor 18b disposed at the second surface 15b of the circuit board 15, the inner case 20 includes the first protrusion 10 as a first adjustment portion that adjusts a thickness of the filling material 31 such that a portion overlapping the inertial sensor 18a in a plan view is thinner than other portions, the outer case 1 includes the second protrusion 11 as a second adjustment portion that adjusts a thickness of the filling material 32 such that a portion overlapping the inertial sensor 18b in the plan view is thinner than other portions, the filling material 32 fills between the second surface 15b of the circuit board 15 and the inertial sensor 18b, and the outer case 1, and heights of the first protrusion 10 and the second protrusion 11 are adjusted such that the thickness of the filling material 31 and the thickness of the filling material 32 are substantially the same in portions overlapping the inertial sensor 18b in the plan view. The thickness of the filling material 31 is the same as the thickness of the filling material 32 in a preferred example, and may be different. Except for these points, a configuration is the same as that of the inertial measurement device 110 according to the second embodiment.

As described above, according to the inertial measurement device 130 in the embodiment, the following effects can be attained in addition to the effects according to the above embodiment.

The inertial measurement device 130 further includes the inertial sensor 18b disposed at the second surface 15b of the circuit board 15, the inner case 20 includes the first protrusion 10 as the first adjustment portion that adjusts the thickness of the filling material 31 such that the portion overlapping the inertial sensor 18a in the plan view is thinner than other portions, the outer case 1 includes the second protrusion 11 as the second adjustment portion that adjusts the thickness of the filling material 32 such that the portion overlapping the inertial sensor 18b in the plan view is thinner than other portions, the filling material 32 fills between the second surface 15b of the circuit board 15 and the inertial sensor 18b, and the outer case 1, and the heights of the first protrusion 10 and the second protrusion 11 are adjusted such that the thickness of the filling material 31 and the thickness of the filling material 32 are substantially the same in the portions overlapping the inertial sensor 18b in the plan view.

According to this, the circuit board 15 is filled with the filling materials 31 and 32 on the front and back surfaces thereof, and is integrated with the inner case 20 and the outer case 1 to be rigid. This can prevent warping of the circuit board 15. By averaging outputs of the inertial sensors 18a and 18b mounted on both surfaces of the circuit board 15, influence of a stress can be offset, and thus detection accuracy can be further improved.

Since thicknesses of the filling materials 31 and 32 can be reduced by providing the first protrusion 10 and the second protrusion 11, when resin forming the filling materials 31 and 32 absorbs moisture, an expansion amount of the resin present in a thickness direction of the inertial sensors 18a and 18b can be minimized, and influence of a stress applied to the inertial sensor 18a and 18b can be further limited.

Therefore, it is possible to provide the inertial measurement device 130 having excellent moisture resistance and high detection accuracy.

### Fifth Embodiment

### Different Mounting Mode-4

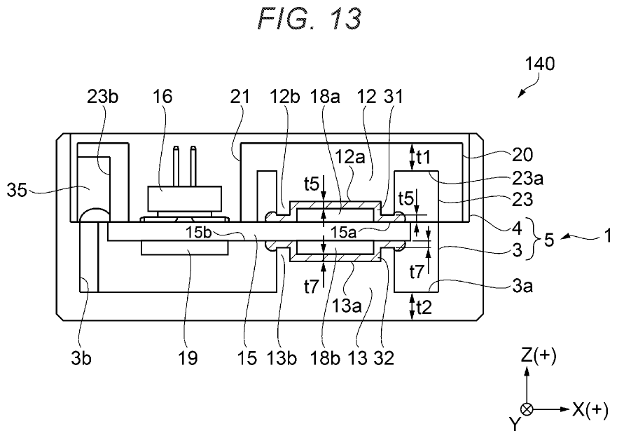

FIG. 13 is a cross-sectional view of an inertial measurement device according to a fifth embodiment, and corresponds to FIG. 12.

Filling amounts of the filling materials 31 and 32 may be reduced by modifying configurations of the first protrusion 10 and the second protrusion 11 according to the fourth embodiment. Hereinafter, the same portions as those according to the fourth embodiment are denoted by the same reference signs, and redundant description thereof will be omitted.

As shown in FIG. 13, an inertial measurement device 140 according to the embodiment includes the inertial sensor 18b as a second inertial sensor at the second surface 15b in addition to the inertial sensor 18a at the first surface 15a. The inertial measurement device 140 further includes a first protrusion 12 that is a protrusion protruding from the bottom 23a of the cavity 23 of the inner case 20 toward the circuit board 15, and a second protrusion 13 that is a protrusion protruding from the bottom 3a of the board accommodating portion 3 of the outer case 1 toward the circuit board 15.

A recess 12a as a first recess is formed in a top portion of the first protrusion 12. The recess 12a is formed corresponding to a shape of the inertial sensor 18a, and covers the inertial sensor 18a including side surfaces. The recess 12a is surrounded by side walls 12b. In a preferred example, the dimension t5 between a bottom portion of the recess 12a and the inertial sensor 18a is set to 2 mm or less. More preferably, the dimension t5 is set to 1 mm or less. A dimension between the side wall 12b and the first surface 15a of the circuit board 15 is also the dimension t5. Here, the filling material 31 fills the recess 12a and covers the inertial sensor 18a and the surrounding first surface 15a of the circuit board 15, but does not fill the cavity 23 entirely. In other words, the filling material 31 covers the inertial sensor 18a and selectively fills between the first protrusion 12 and the first surface 15a of the circuit board 15.

A recess 13a as a second recess is formed in a top portion of the second protrusion 13. The recess 13a is formed corresponding to a shape of the inertial sensor 18b, and covers the inertial sensor 18b including side surfaces. The recess 13a is surrounded by side walls 13b. In a preferred example, the dimension t7 between a bottom portion of the recess 13a and the inertial sensor 18b is set to 2 mm or less. More preferably, the dimension t7 is set to 1 mm or less. A dimension between the side wall 13b and the second surface 15b of the circuit board 15 is also the dimension t7.

The filling material 32 fills the recess 13a and covers the inertial sensor 18b and the surrounding second surface 15b of the circuit board 15, but does not fill the board accommodating portion 3 entirely. In other words, the filling material 32 covers the inertial sensor 18b and selectively fills between the second protrusion 13 and the second surface 15b of the circuit board 15. In a preferred example, the dimension t5 and the dimension t7 are the same, and the filling material 31 including the inertial sensor 18a and the filling material 32 including the inertial sensor 18b are front-back symmetrical. By forming the filling material 31 and the filling material 32 into a symmetrical structure, it is possible to avoid a difference in expansion amount between front and back sides when both materials absorb moisture.

In other words, the inertial measurement device 140 further includes the inertial sensor 18b disposed at the second surface 15b of the circuit board 15, the inner case 20 has the recess 12a in the first protrusion 12 as the first recess formed corresponding to the shape of the inertial sensor 18a, the outer case 1 has the recess 13a in the second protrusion 13 as the second recess formed corresponding to the shape of the inertial sensor 18b, the filling material 31 fills between the first surface 15a of the circuit board 15 and the inertial sensor 18a, and the first protrusion 12 (recess 12a), and the filling material 32 fills between the second surface 15b of the circuit board 15 and the inertial sensor 18b, and the second protrusion 13 (recess 13a). Except for these points, a configuration is the same as that of the inertial measurement device 130 according to the fourth embodiment.

As described above, according to the inertial measurement device 140 in the embodiment, the following effects can be attained in addition to the effects according to the above embodiment.

The inertial measurement device 140 further includes the inertial sensor 18b disposed at the second surface 15b of the circuit board 15, the inner case 20 has the recess 12a in the first protrusion 12 as the first recess formed corresponding to the shape of the inertial sensor 18a, the outer case 1 has the recess 13a in the second protrusion 13 as the second recess formed corresponding to the shape of the inertial sensor 18b, the filling material 31 fills between the first surface 15a of the circuit board 15 and the inertial sensor 18a, and the first protrusion 12 (recess 12a), and the filling material 32 fills between the second surface 15b of the circuit board 15 and the inertial sensor 18b, and the second protrusion 13 (recess 13a).

According to this, the circuit board 15 is filled with the filling materials 31 and 32 on the front and back surfaces thereof at portions overlapping the inertial sensors 18a and 18b, and is integrated with the inner case 20 and the outer case 1 to be rigid. This can prevent warping of the circuit board 15. By averaging outputs of the inertial sensors 18a and 18b mounted on both surfaces of the circuit board 15, influence of a stress can be offset, and thus detection accuracy can be further improved.

The filling material 31 selectively fills between the first protrusion 12 and the first surface 15a of the circuit board 15, and the filling material 32 selectively fills between the second protrusion 13 and the second surface 15b of the circuit board 15, whereby it is not required to fill the cavity 23 and the board accommodating portion 3 entirely. Therefore, an amount of resin forming the filling materials 31 and 32 can be reduced, and manufacturing efficiency can be improved. When the resin forming the filling materials 31 and 32 absorbs moisture, an expansion amount of the resin present in a thickness direction of the inertial sensors 18a and 18b can be minimized, and influence of a stress applied to the inertial sensor 18a and 18b can be further limited.

Therefore, it is possible to provide the inertial measurement device 140 having excellent moisture resistance and high detection accuracy.

### Sixth Embodiment

### Different Mounting Mode-5

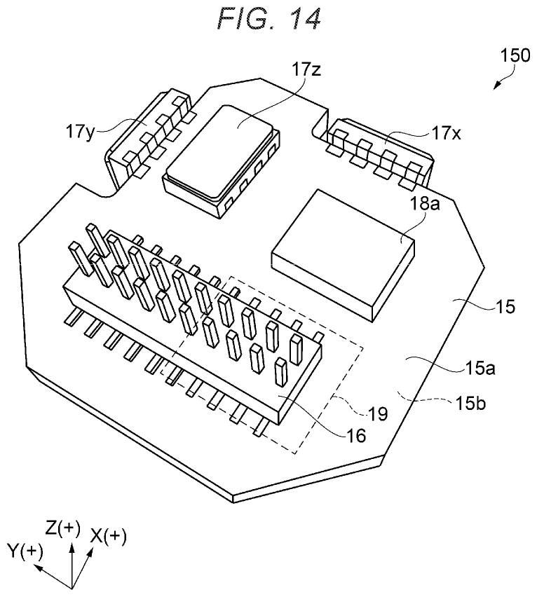

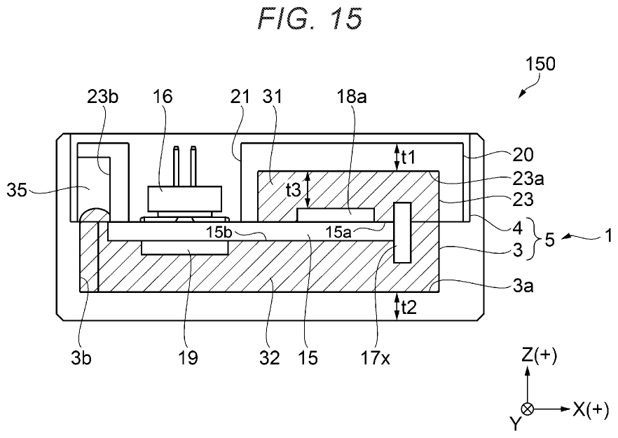

FIG. 14 is a perspective view of a circuit board according to a sixth embodiment, and corresponds to FIG. 4. FIG. 15 is a cross-sectional view of an inertial measurement device, and corresponds to FIG. 6.

One inertial sensor 18a is mounted on the circuit board 15 in the first embodiment, but the disclosure is not limited to this configuration, and an angular velocity sensor may be further provided. Hereinafter, the same portions as those according to the first embodiment are denoted by the same reference signs, and redundant description thereof will be omitted.

FIG. 14 is a perspective view of the circuit board 15 of an inertial measurement device 150 according to the embodiment. As shown in FIG. 14, three angular velocity sensors 17x, 17y, and 17z are mounted on the circuit board 15 in addition to the connector 16, the inertial sensor 18a, and the control IC 19.

The angular velocity sensor 17x is a gyro sensor that detects an angular velocity around the X axis, and is mounted on a side surface of one side of the circuit board 15 in the X(+) direction. A vibrating gyro sensor that uses quartz crystal as a vibrator and that detects an angular velocity based on a Coriolis force applied to a vibrating object is used in a preferred example. The sensor is not limited to the vibrating gyro sensor, and may be any sensor capable of detecting an angular velocity. For example, a sensor using ceramic or silicon as a vibrator may be used.

The angular velocity sensor 17y is a gyro sensor that detects an angular velocity around the Y axis, and is mounted on a side surface of one side of the circuit board 15 in the Y(+) direction.

The angular velocity sensor 17z is a gyro sensor that detects an angular velocity around a Z axis, and is mounted on the first surface 15a of the circuit board 15. The angular velocity sensor 17y and the angular velocity sensor 17z are the same gyro sensor as the angular velocity sensor 17x, and these sensors correspond to inertial sensors. Since the angular velocity sensors 17x, 17y, and 17z use quartz crystal as vibrators, the angular velocity sensors 17x, 17y, and 17z have excellent temperature characteristics, are less likely to be affected by external noise or temperature, and have high detection accuracy, as compared with a gyro sensor element manufactured using a MEMS technique.

As shown in FIG. 15, the cavity 23 of the inner case 20 is filled with the filling material 31, and the board accommodating portion 3 of the outer case 1 is filled with the filling material 32.

The filling material 31 covers the electronic components including the inertial sensor 18a and the angular velocity sensor 17z, and fills the cavity 23. Similarly, the filling material 32 covers the electronic components including the control IC 19 and fills the board accommodating portion 3.

As shown in FIG. 15, a half of the angular velocity sensor 17x in a Z plus direction is located in the cavity 23, and a half of the angular velocity sensor 17x in a Z minus direction is located in the board accommodating portion 3, whereby the angular velocity sensor 17x is covered with the filling material 31 and the filling material 32 all around. Similarly, the angular velocity sensor 17y is also covered with the filling material 31 and the filling material 32 all around. Except for these points, a configuration is the same as that of the inertial measurement device 100 according to the first embodiment.

As described above, according to the inertial measurement device 150 in the embodiment, the following effects can be attained in addition to the effects according to the above embodiment.

The inertial measurement device 150 includes highly accurate angular velocity sensors 17x, 17y, and 17z using quartz crystal as vibrators, in addition to the configuration of the inertial measurement device 100 having excellent moisture resistance and high detection accuracy.

Therefore, it is possible to provide the inertial measurement device 150 having excellent reliability and high accuracy.

What is claimed is:

1. An inertial measurement device comprising:
a first case and a second case;
a board that is disposed in a space formed by the first case and the second case, that includes a first surface and a second surface, and in which a first inertial sensor is disposed at the first surface;
a first filling material configured to fill between the first surface of the board and the first case and between the first inertial sensor and the first case; and
a second filling material configured to fill between the second surface of the board and the second case.

2. The inertial measurement device according to claim 1, comprising
a second inertial sensor disposed at the second surface of the board, wherein
the second filling material fills between the second surface of the board and the second case and between the second inertial sensor and the second case.

3. The inertial measurement device according to claim 1, wherein
the first case includes a first adjustment portion configured to adjust a thickness of the first filling material such that a portion overlapping the first inertial sensor in a plan view is thinner than other portions, and
the second case includes a second adjustment portion configured to adjust a thickness of the second filling material such that a portion overlapping the first inertial sensor in the plan view is thinner than other portions.

4. The inertial measurement device according to claim 3, wherein
the first adjustment portion and the second adjustment portion adjust the thickness of the first filling material and the thickness of the second filling material to be substantially the same in portions overlapping the first inertial sensor in the plan view.

5. The inertial measurement device according to claim 1, comprising
a second inertial sensor disposed at the second surface of the board, wherein
the first case includes a first adjustment portion configured to adjust a thickness of the first filling material such that a portion overlapping the first inertial sensor in a plan view is thinner than other portions,
the second case includes a second adjustment portion configured to adjust a thickness of the second filling material such that a portion overlapping the second inertial sensor in the plan view is thinner than other portions,
the second filling material fills between the second surface of the board and the second case and between the second inertial sensor and the second case, and
the first adjustment portion and the second adjustment portion adjust the thickness of the first filling material and the thickness of the second filling material to be substantially the same in portions overlapping the second inertial sensor in the plan view.

6. The inertial measurement device according to claim 3, wherein
the first adjustment portion is a protrusion provided in the first case, and
the second adjustment portion is a protrusion provided in the second case.

7. The inertial measurement device according to claim 1, wherein
a second inertial sensor disposed at the second surface of the board is provided,
the first case has a first recess formed corresponding to a shape of the first inertial sensor,
the second case has a second recess formed corresponding to a shape of the second inertial sensor,
the first filling material fills between the first surface of the board and the first recess and between the first inertial sensor and the first recess, and
the second filling material fills between the second surface of the board and the second recess and between the second inertial sensor and the second recess.

8. The inertial measurement device according to claim 1, wherein
the first case is accommodated in an accommodating portion of the second case, and
the accommodating portion includes a stopper portion configured to prevent the first case from falling.

9. The inertial measurement device according to claim 8, wherein
a first cutout portion is formed on one side of the first case,
a second cutout portion is formed in the accommodating portion of the second case, and
when the first case is set in the accommodating portion of the second case, a storage portion that stores the overflowed second filling material is formed by the first cutout portion and the second cutout portion.
